(19) United States
(12) Patent Application Publication
(10) Pub. No.: US 2006/0065999 A1
(43) Pub. Date: Mar. 30, 2006

(54) Scored trim coil

(75) Inventors: Carl Anderson, Scranton, PA (US); Kevin Jablonski, Scranton, PA (US)

Correspondence Address: KATTEN MUCHIN ROSENMAN LLP, 575 MADISON AVENUE, NEW YORK, NY, 10022-2585, US

(73) Assignee: ALUM-A-POLE

(21) Appl. No.: 11/226,107

(22) Filed: Sep. 14, 2005

Related U.S. Application Data
(60) Provisional application No. 60/612,746, filed on Sep. 24, 2004.

(51) Int. Cl. B26D 3/08

(52) U.S. Cl. 264/138; 425/291

(57) ABSTRACT

A method of scoring PVC/vinyl trim coil is provided to allow for bending trim coil with ease. Rolling blades are used to form an indentation on one side of the trim coil and a protrusion on the other to create a score line or crease to facilitate bending. Once bent, the material retains its position. In alternate embodiments, only an indentation is provided on one side while the other side remains flat, or indentations are provided on directly opposite each other on each side to create a hinge. Washers may be used in conjunction with the blades to eliminate waving of the trim coil while scoring. Preferably, the coil is scored to produce bends to be used as flashing material on chemically-treated wood, such as the material utilized on wood decks.

### CROSS-REFERENCE TO RELATED APPLICATION

This application claims priority from U.S. Provisional Application 60/612,746 filed on Sep. 24, 2004, the contents of which are herein wholly incorporated by reference.

### I. BACKGROUND OF THE INVENTION

A. Field of Invention

The present invention relates generally to the field of trim moldings. More specifically, the present invention is related to bending and scoring trim coil for siding and trim purposes.

B. Discussion of Prior Art

Within the building industry, there has been an ongoing problem with flashing or trim coil used against pressure treated lumber. Traditionally, contractors have been provided with aluminum and copper flashing. Decks made out of wood have one or more chemicals placed on them to cure the wood and retain it. Such chemicals interact with aluminum coil and, as a result, the aluminum which is typically utilized for decks can not be used when the deck is treated. A good example is CCA and ACQ pressure treated lumber. When aluminum is used with these chemically treated woods, the aluminum flashing will rot.

It has been suggested to use copper for such trim or flashing. However, copper it is both expensive and difficult to manipulate. The industry, therefore, does not have adequate flashing or trim material to serve such a purpose.

It has been found that PVC or vinyl trim coil does not react with CCA or ACQ treated lumber. A detailed description of trim coil made of PVC/vinyl material is provided in U.S. Pat. No. 5,551,201, which is hereby incorporated by reference. The trim coil described in the '201 patent would be extremely useful as deck flashing as it is corrosion and weather resistant.

Furthermore, the unique composition of the described trim coil means it may be bent to return to its original shape or to retain and remain in bended shape. With proper score lines, the vinyl material may also be used on posts that are used in conjunction with decking, or any posts that may be coated and treated with such chemicals.

The difficulty in using vinyl trim is that it requires a bending brake for bending and cutting the vinyl coil. In its current form (coiled or rolled), a contractor or homeowner would need to use a bending brake in order to bend and cut the coil to size in order to utilize it as flashing.

A bending brake is a sophisticated piece of equipment that is unavailable to most people. Siding contractors commonly own a brake, but it is cost prohibitive to a contractor and, especially, to a homeowner who does not specialize in the siding field. Currently, this machine is required as there are no other methods of bending the vinyl into the necessary shapes desired.

In the absence of readily available means to bend or score vinyl coil, bent vinyl pieces are shipped pre-shaped from a supplier. Intermediate suppliers, wholesalers and retailers incur costs associated with shipping finished goods rather being able to use cheaper shipping methods associated with bulk or flat products. Retailers incur further costs associated with inefficiently using a larger display area for exhibiting pre-shaped pieces. End users, such as homeowners and contractors, also incur costs in bringing pre-shaped vinyl pieces home or to the job site.

Therefore, a process to score or pre-form a bend or crease in vinyl trim coil would be beneficial from many aspects-reducing shipping costs, display and retail costs, and end-user costs. Furthermore, a process that enables vinyl coil to be hand bent after scoring would ease the process of providing flashing on areas such as pretreated wood decks or posts.

Whatever the precise merits, features, and advantages of the prior art, none achieves or fulfills the purposes of the present invention.

### II. SUMMARY OF THE INVENTION

A method for scoring and bending vinyl trim coil is provided that allows for easy manipulation by hand. Rollers or forming blades are used to score the trim coil. A pocket is provided on one of the forming blades to create a blip, an indentation on one side and protrusion on the other side, on the trim coil.

The resulting score line or crease may be formed in a number of places, such that the desired bends, for example 45 degrees and 90 degrees, may be formed. Shoulder washers may be provided on the forming blades to decrease or eliminate waviness of the trim coil material. Alternatively, rather than forming a blip, a single indentation may be formed on one side of the trim coil while the other remains flat. Also, as another alternative, indentations may be formed directly opposite each other on either side of the trim coil to form a hinge.

Combinations of score lines or creases may be used to effect any type of bend. Thus, score lines or creases may effect a finished piece that can be bent into a Z, U, W, L, V, 0, P, J, or similar shape in cross-section.

### III. BRIEF DESCRIPTION OF THE DRAWINGS

FIG. 1 illustrates the preferred embodiment and method of using rollers to score trim coil of the present invention.

FIGS. 2a and 2b illustrate a front view and a detail of the rollers used in the preferred method of scoring trim coil.

FIG. 3 illustrates a front view of the preferred method of scoring trim coil.

FIG. 4 illustrates scored trim coil as provided by the present invention.

FIG. 5a illustrates alternative scores in trim coil.

FIG. 5b illustrates alternative bends made by the scores in FIG. 5a in trim coil.

FIG. 6a illustrates additional alternative scores in trim coil.

FIG. 6b illustrates alternative bends made by the scores in FIG. 6a in trim coil.

FIG. 7 illustrates a first alternative method of using rollers to score trim coil.

FIG. 8 illustrates the score of the trim coil formed from the first alternative method.

FIGS. 9a, 9b and 9c illustrate a second alternative method using rollers to score trim coil.

FIG. 10 illustrates the score of the trim coil formed from the second alternative method.

FIGS. 11a and 11b illustrate a third alternative method of using rollers to score trim coil.

FIG. 12 illustrates the score of the trim coil formed from the third alternative method.

### IV. DESCRIPTION OF THE PREFERRED EMBODIMENTS

While this invention is illustrated and described in a preferred embodiment, the device may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

As previously noted, the detailed description of the PVC/vinyl trim coil preferably used in the present invention is provided in U.S. Pat. No. 5,551,201, which is hereby incorporated by reference. As PVC or vinyl trim coil is corrosion and weather resistant and it does not react with CCA or ACQ treated lumber, it would be extremely useful as deck flashing. Furthermore, the unique composition of the described trim coil may be bent to return to its original shape or to retain and remain in bended shape. With proper score lines, the vinyl material may be hand bent and used on posts used in conjunction with decking, or any posts that may be coated and treated with such chemicals. The methods of obtaining score lines in vinyl trim coil are described in the preferred and alternate embodiments below.

Prior to the present invention, it was unclear how vinyl would react to scoring. It was conjectured that the vinyl would crack or that the vinyl would actually retain its shape with the scoring or would return to its original shape when attempts would be made to score it. After testing and experimenting using different scoring depths, good results were obtained.

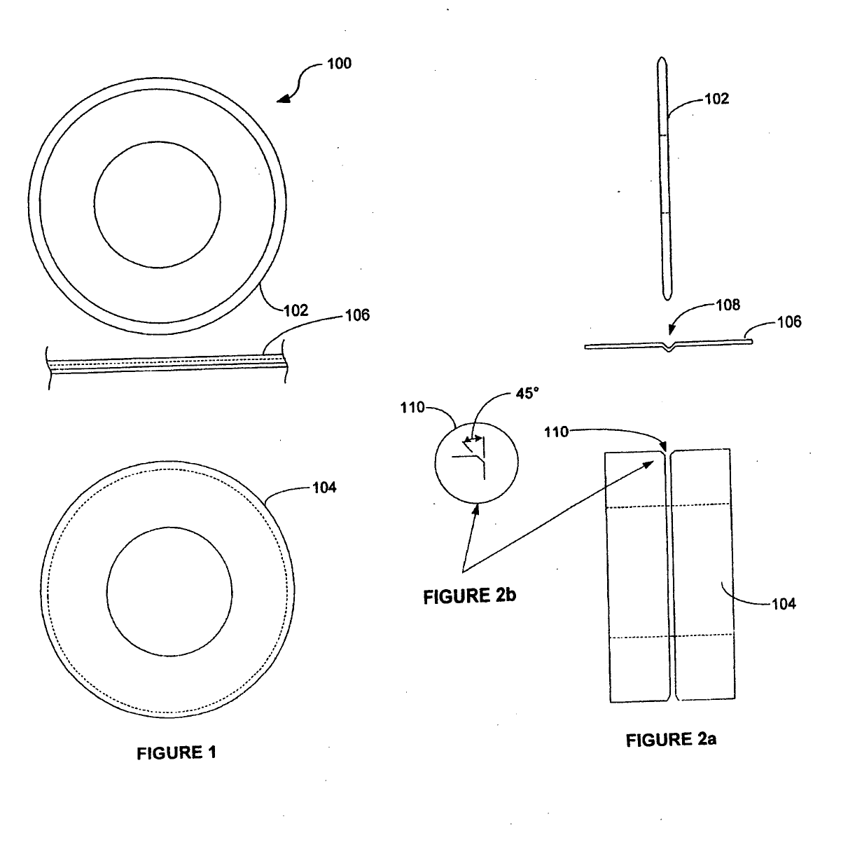

FIGS. 1, 2a and 2b illustrate the preferred embodiment and method of using rollers to score trim coil of the present invention. Rolling equipment 100 comprises two rollers, a top forming blade 102 and a bottom forming blade 104 as shown in a side view in FIG. 1 disposed on rollers. Top forming blade 102 may have, for example, a cross-sectional thickness of 0.100 inches.

Typically, forming blades are used that have a radius slightly less than 3 inches, where the difference is the cross-sectional thickness of the coil when forming into a pocket or one half of the cross-sectional thickness of the coil when forming against another forming blade. The cooperating forming blades are typically spaced 3.000 inches apart, measuring center to center.

As shown in FIG. 2a, bottom forming blade 104 preferably comprises pocket 110. Pocket 110 comprises an angled end designed to aid in the scoring of vinyl coil 106. For example, coil 106 may have a range of thickness from 0.015 to 0.060 inches, wherein usual coil thicknesses are 0.015 inches, 0.030 inches, and 0.060 inches. Pocket 110 may be 0.062 inches wide, and the angled end of pocket 110 may have an angle of 45 degrees, shown in FIG. 2b.

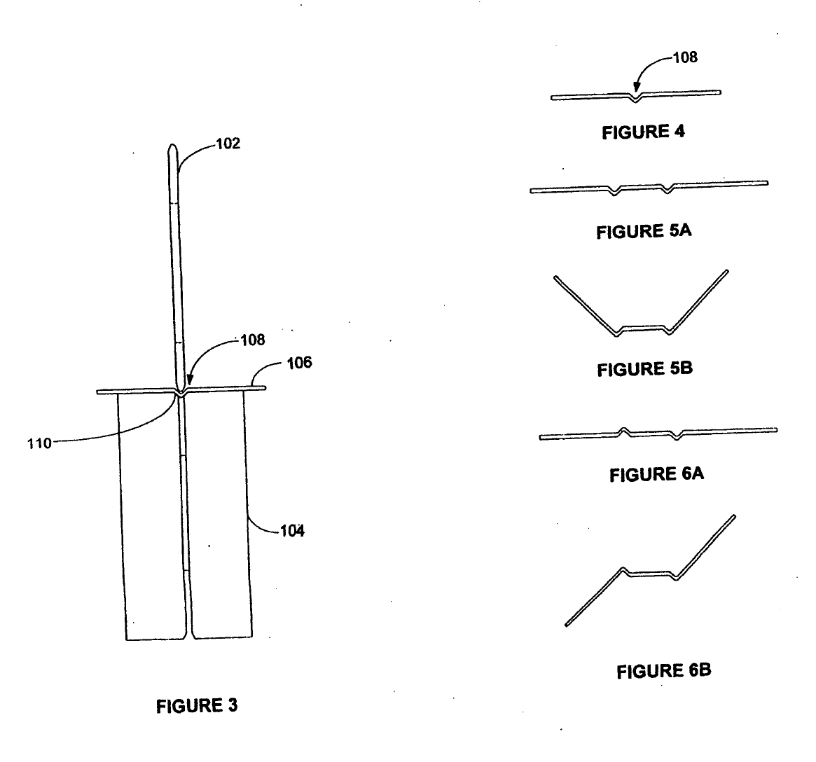

The method of scoring vinyl coil 106 is shown in FIG. 3. Vinyl coil 106 is placed between top and bottom forming blades 104 and 102, respectively. As top forming blade 102 runs along coil 106, it pushes coil 106 into pocket 110 of bottom forming blade 104. This pressure forms blip 108. Blip 108 in this case is defined by the indentation on the one side of coil 106 and protrusion on the opposite side. An example of the scoring process or blip 108 formed in coil 106 is shown in FIG. 4. The formation of blip 108 in the material permits easy bending and retention of the bent position. The material may thereafter be hand-bent along the score lines in the direction required.

FIG. 4 illustrates a cross-sectional view of a coil having a single blip or score line on the coil for bending. The coil may be bent to form a number of angles, such as a 45 degree or 90 degree bend. FIGS. 5a, 5b, 6a and 6b illustrate cross-sectional views of a coil 106 as additional examples of scores and bends that may be made in the trim coil. FIG. 5a illustrates the scoring of two blips one the same side. This allows for bending upward as shown in FIG. 5b, such that a W or U shape may be made with coil 106. FIG. 6a illustrates the scoring of two blips on opposite sides, such that there is an indentation and protrusion on each side. This allows for bending in opposite directions as shown in FIG. 6b.

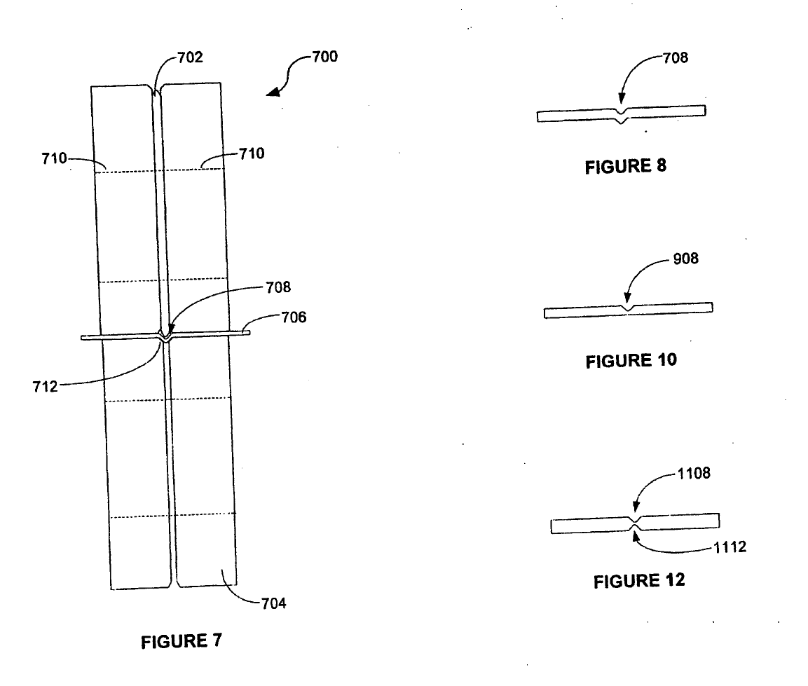

FIG. 7 illustrates a front view of a first alternative method of scoring trim coil. The trim coil 706 is shown in a cross-sectional view. Rolling equipment 700 is provided with top and bottom forming blades 702 and 704, respectively. In this alternative embodiment, however, there is the addition of shoulder washers 710 on both sides of top forming blade 702. Washers 710 confine trim coil 706 to decrease or eliminate waving in the material, thus providing a flatter piece with a more uniform crease. FIG. 8 illustrates an example of score line 708 provided by this embodiment. Score 708 is preferably a blip having indentation on one side, protrusion on the other side. Score 708 or crease, created by the combination of blades 702 and 704, washers 710, and pocket 712, provides a bubble on one side of coil 706. The bubble gives the user a visual indication of which way to bend the material. As this embodiment provides a deep score line, it is easy to bend by hand. When bent, the bubble crease will yield a rounded out corner.

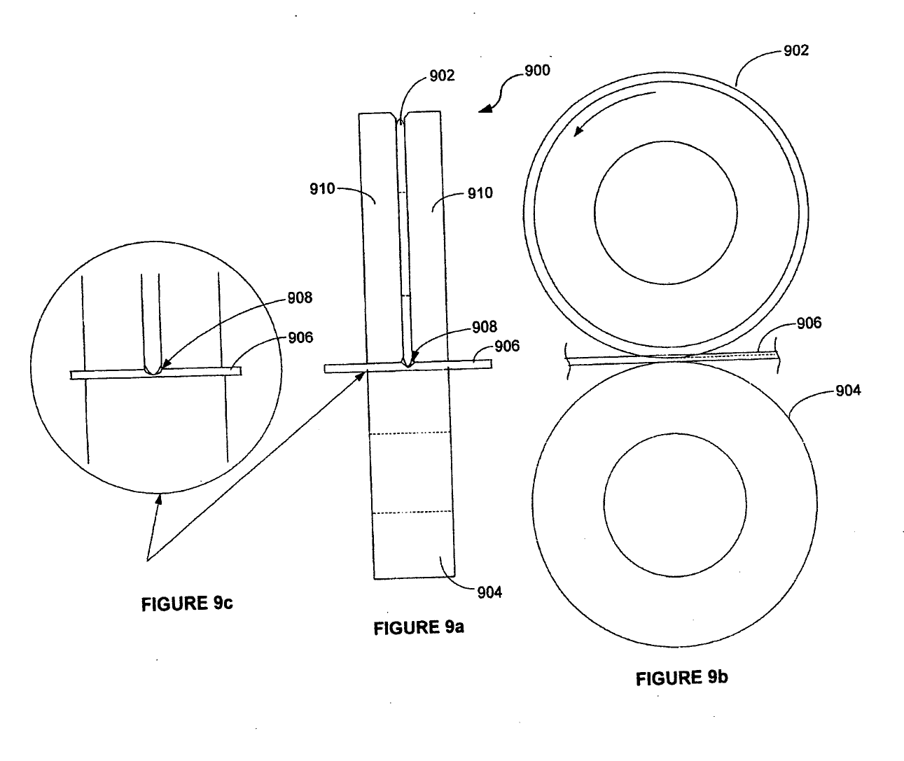

FIGS. 9a and 9b illustrate a front and side view of a second alternative method using rollers to score trim coil, respectively. FIG. 9c shows a detail of a coil being formed. Alternatively, rather than forming a blip, a single indentation is sufficient. Rolling equipment 900 is provided with top and bottom forming blades 902 and 904, respectively, as well as shoulder washers 910 on both sides of top forming blade 902. In this embodiment, bottom forming blade 904, however, does not have a pocket. Rather, as top forming blade 902 pushes upon one side of trim coil 906, bottom forming blade 904 flattens the material to a specific thickness, thus forming an indentation, allowing the material to become a hinge. FIG. 10 illustrates an example of score line 908 provided by this embodiment. Score line 908 comprises an indentation along one side of the coil while the other side remains flat. Although the material may be bent along score line 908 in either direction, bending is best accomplished if bent inward, toward the crease. This provides a sharp outside corner, similar to bending coil on the traditional bending brake device.

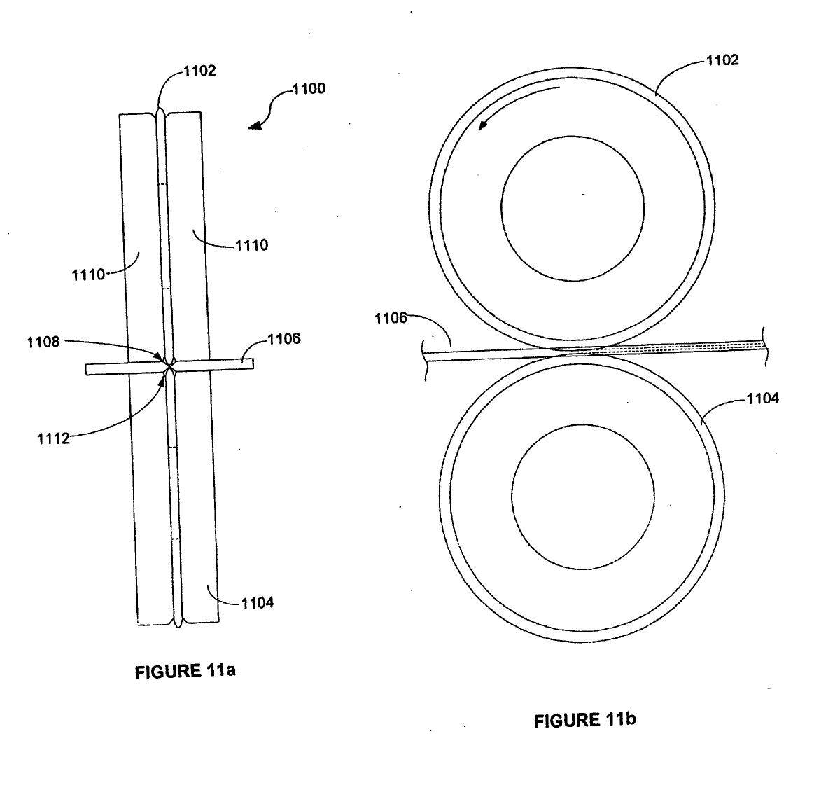

FIGS. 11a and 11b illustrate a front and side view of a third alternative method of using rollers to score trim coil, respectively. Rolling equipment 1100 is provided with top and bottom forming blades 1102 and 1104, respectively, as well as shoulder washers 1110 on both sides of top forming blade 1102 and bottom forming blade 1104. In this embodiment, however, top and bottom forming blades 1102 and 1104 are provided to form top and bottom score lines or creases 1108 and 1112 (respectively). FIG. 12 best illustrates creases 1108 and 1112 formed in coil 1106 in this embodiment. Creases 1108 and 1112 are indentations directly opposite each other on opposing sides. Creases 1108 and 1112 thus provide a hinge that may be bent in either direction.

The rollers and methods used for making scored trim coil allow for the use of vinyl coil on decks as flashing, as well as for wrapping joints, posts, etc. Also, if not for immediate use, the vinyl coil may be scored and rolled as a pre-scored roll or may be cut into elongated strips for sale in stores.

Advantageously, elongated strips may also be cut at a job site using readily available tools, and then easily bent or folded to fit.

### V. CONCLUSION

A system and method has been shown in the above embodiments for the effective implementation of a scored trim coil. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by size, materials, or specific manufacturing techniques.

What is claimed is:

1. A method for scoring vinyl trim coil, the method comprising the steps of:
a. providing a substantially flat web of vinyl trim coil;
b. feeding the web between a top and a bottom roller, one of the top and the bottom roller having a forming blade;
c. applying a pressure to the forming blade;
d. pushing a portion of the web using the forming blade against the other of the top and bottom roller to form a score.

2. The method of claim 1 further comprising the steps of
e. reversing the web which has already been scored to a side not having an indentation;
f. feeding the web between the top and the bottom roller;
g. applying a pressure to the forming blade;
h. pushing a second portion of the web using the forming blade against the other of the top and bottom roller to form a second score.

3. The method of claim 2, wherein the second score is directly opposed to the score formed before the second score.

4. The method of claim 1, wherein the other of the top and the bottom roller has a pocket disposed between a pair of shoulders, the pocket sized to receive the portion of the web when the web is being scored; and wherein the forming blade pushes the portion of the web into the pocket to form the score.

5. The method of claim 4, wherein the pocket comprises a width of 0.062 inches.

6. The method of claim 5, wherein the pocket comprises angled ends having walls angled 45 degrees.

7. The method of claim 4, wherein the one of the top and bottom shoulder having a forming blade further comprises a second pair of shoulders, the forming blade disposed between the shoulders of the second pair of shoulder, and wherein the web is stabilized between the pairs of shoulders.

8. The method of claim 1, wherein the other of the top and the bottom roller comprises a second forming blade, wherein the second forming blade pushes the portion of the web into the pocket to form a second score simultaneously with the score formed in step (d).

9. The method of claim 8, wherein the second score the second score is directly opposed to the score formed in step (d).

10. The method of claim 1, wherein the forming blade has a cross-sectional thickness of 0.100 inches.

11. The method of claim 1, further comprising rotating one of the top and bottom roller to advance the web and form a score line.

12. A method of scoring vinyl trim coil to fit a structural object, the method comprising the steps of:
a. determining a shape of the trim coil to fit the structural object;
b. determining a number of score lines to form the shape;
c. feeding a web of the vinyl trim coil between a top and a bottom roller, one of the top and bottom roller having a forming blade;
d. applying a pressure to the forming blade;
e. pushing a portion of the web against the other of the top and bottom roller to form a first score;
f. rotating one of the top and bottom roller to advance the web and form a score line; and
g. repeating steps (c)-(f) to form all the score lines determined in step (b) to form the shape.

13. The method of claim 12 further comprising prior to step f the steps of
aa. turning the web which has already been scored to a reverse side;
bb. feeding the web between the top and the bottom roller;
cc. advancing the forming blade against a second portion of the web;
dd. pushing the second portion of the web using the forming blade against the other of the top and bottom roller to form a second score, and
wherein step (g) further comprises the above steps (aa), (bb), (cc) and (dd).

14. The method of claim 12, wherein the other of the top and the bottom roller has a pocket disposed between a pair of shoulders, the pocket sized to receive the portion of the web when the web is being scored; and wherein the forming blade pushes the portion of the web into the pocket to form the score.

15. The method of claim 14, wherein the one of the top and bottom shoulder having a forming blade further comprises a second pair of shoulders, the forming blade disposed between the shoulders of the second pair of shoulder, and wherein the web is stabilized between the pairs of shoulders.

16. The method of claim 12, wherein the other of the top and the bottom roller comprises a second forming blade, wherein the second forming blade pushes the portion of the web into the pocket to form a second score simultaneously with the score formed in step (d).

17. The method of claim 16, wherein the second score the second score is directly opposed to the score formed in step d.

18. The method of claim 14, wherein the pocket comprises a width of 0.062 inches.

19. The method of claim 18, wherein the pocket comprises angled ends having walls angled 45 degrees.

20. The method of claim 12, wherein the forming blade has a cross-sectional thickness of 0.100 inches.

21. An apparatus for scoring a web of vinyl trim coil, the apparatus comprising:
a top and a bottom roller, one of the top and the bottom roller having a forming blade and the other of the top and the bottom roller having a pocket;
wherein the forming blade applies a pressure on a portion of the web to push the portion of the web into the pocket to form a score, the pocket being sized to receive the portion of the web.

22. The apparatus of claim 21, wherein the pocket comprises a width of 0.062 inches.

23. The apparatus of claim 22, wherein the pocket comprises angled ends having walls angled 45 degrees.

24. The apparatus of claim 21, wherein the forming blade has a cross-sectional thickness of 0.100 inches.

25. The apparatus of claim 21, wherein the other of the top and bottom rollers having the pocket further comprises a first pair of shoulders, the pocket being disposed between the shoulders of the first pair of shoulders.

26. The apparatus of claim 26, wherein the one of the top and bottom rollers having the forming blade comprises a second pair of shoulder, the forming blade disposed between the shoulders of the second pair of shoulders, the first and second pairs of shoulders for stabilizing the web.
